(19) United States
(12) Patent Application Publication
(10) Pub. No.: US 2025/0118465 A1
(43) Pub. Date: Apr. 10, 2025

(54) Modified Sintered Neodymium-iron-boron Permanent Magnetic Material and Preparation Method Therefor

(71) Applicant: ZHEJIANG DONGYANG DMEGC RARE EARTH MAGNET CO., LTD, Dongyang, Zhejiang (CN)

(72) Inventors: Xiaoxin AN, Dongyang, Zhejiang (CN); Zhongbin HAO, Dongyang, Zhejiang (CN); Xiaolang LIU, Dongyang, Zhejiang (CN); Qunfeng HONG, Dongyang, Zhejiang (CN)

(21) Appl. No.: 18/031,617

(22) PCT Filed: Nov. 30, 2022
(86) PCT No.: PCT/CN2022/135691

§ 371 Date: Apr. 13, 2023

(30) Foreign Application Priority Data
Jun. 30, 2022 (CN) 202210761631.X

(51) Int. Cl. H01F 1/057; H01F 41/02

(52) U.S. Cl. CPC H01F 1/0577; H01F 1/0576; H01F 41/0266; H01F 41/0273

(57) ABSTRACT

The disclosure provides a modified sintered neodymium-iron-boron permanent magnetic material and a preparation method therefor. The modified sintered neodymium-iron-boron permanent magnetic material includes a first alloy, the first alloy represented by formula (I): (Pr_{0.25}Nd_{0.75})ₐ(LRE)_{b}TM_{c}Fe_{100%-a-b-c-d}B_{d} (I), where LRE is a rare earth element, selected from one or more of elements Gd, Y, and Ce, and at least includes the element Gd, TM is selected from one or more of elements Al, Cu, Co, Ga, Nb, Zr, and Ti, a is 5% to 20%, b is 13% to 28%, c is 0.4% to 5.5%, and d is 0.9% to 1%. The modified sintered neodymium-iron-boron permanent magnetic material provided by the disclosure has a maximum magnetic energy product of 5 MGOe to 30 MGOe, residual magnetism of 6 kGs to 11 kGs, and an intrinsic coercive force of 5 kOe to 11 kOe, and is excellent in high-temperature resistance and low in cost.

### CROSS-REFERENCE TO RELATED APPLICATION

The application is provided on the basis of Chinese Application No. 202210761631.X, filed Jun. 30, 2022, which claims the benefit of priority to the Chinese Patent Application, which is incorporated by reference in its entirety herein.

### TECHNICAL FIELD

The disclosure relates to the technical field of rare earth permanent magnetic materials, and in particular to a modified sintered neodymium-iron-boron permanent magnetic material and a preparation method therefor.

### BACKGROUND

The magnetized permanent magnetic materials is applied to various fields of industry and life in a wide range due to their less liable to be demagnetized. In accordance with the magnetic energy product, the temperature resistance, and the cost of the permanent magnetic material, a relatively appropriate permanent magnetic material with high cost performance can be selected according to the requirements and features of different application fields.

Among the common permanent magnetic materials, low-cost permanent magnetic ferrite takes a dominant position in the low-end application market despite its low magnetic property (the maximum magnetic energy product (BH) max is less than 5 MGOe). As the third-generation rare earth permanent magnetic material featuring a high magnetic energy product ((BH) max is 30 MGOe to 55 MGOe) and a high coercive force, the sintered neodymium-iron-boron (NdFeB) is competitive in property and cost in the high-property application field. Therefore, the sintered NdFeB permanent magnetic material has replaced the second-generation SmCo series rare earth permanent magnetic material overwhelmingly and become a top choice for high-end applications such as computers, information, communication, household appliances, transportation, and office automation. However, there are still some property gaps in the mid/low-end application fields between the permanent magnetic ferrite and the sintered NdFeB. Especially a permanent magnetic material having (BH) max of 5 MGOe to 30 MGOe has not been reported yet. While the sintered NdFeB and the SmCo series permanent magnet have properties within the range described above, the bonded NdFeB has (BH) max of 13 MGOe only, which is relatively low, and the SmCo series permanent magnet is costly, which makes enterprises under great pressure. Therefore, neither the bonded NdFeB nor the SmCo series permanent magnet can satisfy demands of the low-end application field.

In view of the above, it is of great significance to develop a low-cost permanent magnet having a property between the permanent magnetic ferrite and the sintered NdFeB, so as to satisfy the demands of the mid/low-end application on the permanent magnet and relieve the stress on enterprises.

In recent years, researchers and enterprises have made enormous efforts to reduce the cost of the sintered NdFeB magnet and to promote the low-end application. For example, metal neodymium is replaced with high-abundance rare earth such as La, Ce and Y, which are abundant in reserves and low in cost, so as to reduce the product cost. A large number of permanent magnets having different properties have been invented and industrialized, the majority of which are those having (BH) max higher than 28 MGOe and are applied to the low-end application field having low requirements on use temperature. Research on a sintered NdFeB magnet having a lower magnetic energy product, a lower cost, and higher temperature resistance is less found. Therefore, it is of great practical value to develop such type of magnets.

It is common to replace elements Pr and Nd with the high-abundance rare earth elements La, Ce, and Y, so as to further reduce the cost of the sintered NdFeB magnet without heavy rare earth. However, most methods place more focus on the preparation of the material having a high magnetic energy product and the replacement amount of the high-abundance rare earth element, instead of the high temperature magnetic performance of the material.

Therefore, it is of great significance to research and develop a sintered NdFeB magnetic material having a maximum magnetic energy product (BH) max of 5 MGOe to 30 MGOe, excellent high-temperature resistance, and a low cost.

### SUMMARY

A main objective of the disclosure is to provide a modified sintered neodymium-iron-boron permanent magnetic material and a preparation method therefor, so as to solve poor high-temperature resistance and a high cost of a sintered NdFeB permanent magnetic material in the prior art and to fill in a property gap between an existing sintered NdFeB and an existing bonded NdFeB, thereby solving the problem that an existing permanent magnetic material product hardly satisfies the market demand on a maximum magnetic energy product of 5 MGOe to 30 MGOe.

In order to realize the objective described above, in a first aspect, the disclosure provides a modified sintered NdFeB permanent magnetic material. The modified sintered NdFeB permanent magnetic material includes a first alloy, the first alloy represented by formula (I): (Pr_{0.25}Nd_{0.75})ₐ(LRE)_{b}TM_{c}Fe_{100%-a-b-c-d}B_{d} (I), where LRE is a rare earth element, selected from one or more of elements Gd, Y, and Ce, and at least includes the element Gd, TM is selected from one or more of elements Al, Cu, Co, Ga, Nb, Zr, and Ti, a is 5% to 20%, b is 13% to 28%, c is 0.4% to 5.5%, and d is 0.9% to 1%.

Further, a is 7% to 16%, b is 16% to 26%, e is 0.7% to 3.3%, and d is 0.92% to 0.98%.

Further, the modified sintered NdFeB permanent magnetic material further includes a second alloy, the second alloy represented by formula (II): (Pr_{0.25}Nd_{0.75})ₓTM′_{y}Fe_{100%-x-y-z}B_{z} (II), where TM′ is selected from one or more of elements Al, Cu, Co, Ga, Nb, Zr, and Ti, x is 35% to 45%, y is 0.5% to 9%, and z is 0.5% to 0.9%; where preferably, x is 38% to 42%, y is 1.6% to 4.5%, and z is 0.6% to 0.8%.

Further, by a total weight of the first alloy and the second alloy, a weight percentage of the second alloy is no more than 30 wt %.

Further, LRE includes Gd and Ce, or Gd and Y, or Gd, Y, and Ce; preferably, LRE includes Gd and Ce; and more preferably, LRE includes Gd and Ce, a weight ratio of Gd to Ce is (13-18):(8-10), further more preferably (13-15):(8-10); TM′ is a combination of Co, Cu, and Zr, or a combination of Al, Co, Cu, and Zr, or a combination of Al, Co, Ga, and Zr, or a combination of Al, Cu, Ga, and Zr, or a combination of Al, Co, Cu, Ga, and Zr; preferably, TM′ is a combination of Al, Co, Cu, Ga, and Zr; and more preferably, TM′ is a combination of Al, Co, Cu, Ga, and Zr, a weight ratio of Al to Co to Cu to Ga to Zr is (0-3):(0.2-1.5):(0.1-0.5):(0-0.3):(0.1-0.16), further more preferably (0.2-1.5):(0.2-1.0):(0.1-0.3):(0.1-0.3):(0.1-0.16);
TM is a combination of Al, Co, Cu, Ga, and Zr, or a combination of Al, Co, Cu, Ga, and Nb, or a combination of Al, Co, Cu, Ga, and Ti; preferably, TM is a combination of Al, Co, Cu, Ga, and Zr; and more preferably, TM is a combination of Al, Co, Cu, Ga, and Zr, a weight ratio of Al to Co to Cu to Ga to Zr is (0.2-3):(0.2-1.5):(0.1-0.5):(0.1-0.3):(0.1-0.16), further more preferably (0.2-1.5):(0.2-1.0):(0.1-0.3):(0.1-0.3):(0.1-0.16); and alternatively,
TM is a combination of Al, Co, Cu, Ga, Nb, and Zr, or a combination of Al, Co, Cu, Ga, Zr, and Ti; preferably, TM is a combination of Al, Co, Cu, Ga, Zr, and Ti; and more preferably, TM is a combination of Al, Co, Cu, Ga, Zr, and Ti, a weight ratio of Al to Co to Cu to Ga to Zr to Ti is (0.2-3):(0.2-1.5):(0.1-0.5):(0.1-0.3):(0.04-0.16):(0.05-0.2), further more preferably (0.2-1.5):(0.2-1.0):(0.1-0.3):(0.1-0.3):(0.04-0.12):(0.05-0.15).

Further, a weight ratio of the first alloy to the second alloy is (80-90):(10-20).

In order to realize the objective described above, in another aspect, the disclosure provides a preparation method for the above-described modified sintered NdFeB permanent magnetic material provided by the disclosure. The preparation method for the modified sintered NdFeB permanent magnetic material includes: mixing a Pr—Nd alloy, a LRE source, and a TM source with ferroboron, and performing a first smelting treatment and a first strip casting treatment to obtain a first alloy flakes; where the LRE source is selected from one or more of a Gd—Fe alloy, a Y elementary substance, and a Ce elementary substance; the TM source is selected from one or more of a Al elementary substance, a Cu elementary substance, a Co elementary substance, a Ga elementary substance, a Nb—Fe alloy, a Zr elementary substance, and a Ti elementary substance; performing a crushing treatment on the first alloy flakes to obtain a first powder; performing a orientation forming and pressing treatment on the first powder to obtain a green body; and performing a sintering treatment and tempering treatment on the green body to obtain the modified sintered NdFeB permanent magnetic material.

Further, the preparation method for the modified sintered NdFeB permanent magnetic material further includes: mixing a Pr—Nd alloy and a TM′ source with ferroboron, and performing a second smelting treatment and a second strip casting treatment to obtain a second alloy flakes; where the TM′ source is selected from one or more of a Al elementary substance, a Cu elementary substance, a Co elementary substance, a Ga elementary substance, a Nb—Fe alloy, a Zr elementary substance, and a Ti elementary substance; adding the second alloy flakes during the crushing treatment to perform the crushing treatment with both the first alloy flakes and the second alloy flakes, so as to obtain a second powder; and mixing the second powder with a lubricant before orientation forming; where preferably, the crushing treatment sequentially includes a hydrogen decrepitation treatment and a jet-milling, where an antioxidant is added during the jet-milling, and the second powder is obtained after the jet-milling.

Further, a weight ratio of the first powder, the antioxidant to the lubricant is 100:(0.05-0.2):(0.03-0.15); and preferably, a mean particle size of the first powder is selected from 3.0 μm to 3.8 μm.

Further, a weight ratio of a total weight of the first powder and the second powder, the antioxidant to the lubricant is 100:(0.05-0.2):(0.03-0.15); and preferably, each of mean particle sizes of the first powder and the second powder is selected from 3.0 μm to 3.8 μm.

By applying the technical solution of the disclosure, elements Pr and Nd in a traditional sintered NdFeB permanent magnetic material ((PrNd)—Fe—B) are replaced with rare earth elements (such as Gd, Y, and Ce) of specific types and usage amounts. In one aspect, the modified sintered NdFeB permanent magnetic material having a maximum magnetic energy product (BH) max within a range of 5 MGOe to 30 MGOe and a magnetic property (residual magnetism Br is 6 kGs to 11 kGs, and an intrinsic coercive force Hcj is 5 kOe to 11 kOe) satisfying demands of low-end fields may be obtained. In another aspect, a temperature coefficient of the intrinsic coercive force may be improved under the combined action of the rare earth element of the specific type and the TM element in a specific weight ratio (with value ranges of a, b, c to d strictly controlled) of the disclosure, so that the high-temperature resistance of the material is improved, and the material may be applied under a high-temperature condition. In addition, because the abundance in natural resources of the elements Gd, Y, Ce, etc. obviously higher than that of the elements Pr and Nd, and it may reduce a cost of the material while realizing the effect described above.

### DETAILED DESCRIPTION OF THE EMBODIMENTS

It should be noted that the examples in the disclosure and the features in the examples may be mutually combined without conflicts. The disclosure will be described in detail below in conjunction with the examples.

As described in the background art, an existing sintered NdFeB permanent magnetic material fails to realize both excellent high-temperature resistance and a low cost. Moreover, there is a property gap between an existing bonded NdFeB product and a sintered NdFeB product, so that it is difficult to satisfy the market demand on a maximum magnetic energy product of 5 MGOe to 30 MGOe. In order to solve the technical problem described above, the disclosure provides a modified sintered NdFeB permanent magnetic material. The modified sintered NdFeB permanent magnetic material includes a first alloy, the first alloy represented by formula (I): (Pr_{0.25} Nd_{0.75})ₐ(LRE)_{b}TM_{c}Fe_{100%-a-b-c-d}B_{d} (I), where LRE is a rare earth element includes but not limited to one or more of elements Gd, Y, and Ce, and at least includes the element Gd, TM includes but not limited to one or more of elements Al, Cu, Co, Ga, Nb, Zr, and Ti, a is 5% to 20%, b is 13% to 28%, c is 0.4% to 5.5%, and d is 0.9% to 1%.

It should be noted that a, b, c, and d in the chemical formula represented by formula (I) and x, y, and z in the chemical formula represented by formula (II) of the disclosure refer to weight percentages of corresponding components, respectively.

Elements Pr and Nd in a traditional sintered NdFeB permanent magnetic material ((PrNd)—Fe—B) are replaced with rare earth elements (such as Gd, Y, and Ce) of specific types and use amounts. In one aspect, the modified sintered NdFeB permanent magnetic material having a maximum magnetic energy product (BH) max within a range of 5 MGOe to 30 MGOe and a magnetic property (residual magnetism Br is 6 kGs to 11 kGs, and an intrinsic coercive force Hcj is 5 kOe to 11 kOe) satisfying demands of low-end fields may be obtained. In another aspect, a temperature coefficient of the intrinsic coercive force may be improved under the combined action of the rare earth element of the specific type and the TM element in a specific weight ratio (with value ranges of a, b, c to d strictly controlled) of the disclosure, so that the high-temperature resistance of the material is improved, and the material may be applied under a high-temperature condition. In addition, because the abundance in natural resources of the elements Gd, Y, Ce, etc. obviously higher than that of the elements Pr and Nd, and it may reduce a cost of the material while realizing the effect described above.

In a preferred embodiment, a is 7% to 16%, b is 16% to 26%, c is 0.7% to 3.3%, and d is 0.92% to 0.98%. The value ranges of a, b, c, and d include but are not limited to the ranges described above, respectively. The value range is further limited within the range described above, so as to improve the magnetic property of the modified sintered NdFeB permanent magnetic material and to make the (BH) max of the material within the range of 5 MGOe to 30 MGOe. Moreover, an absolute value of the temperature coefficient of the intrinsic coercive force is reduced, thereby improving the high-temperature resistance of the material.

In a preferred embodiment, the modified sintered NdFeB permanent magnetic material further includes a second alloy, second alloy represented by Formula (II): (Pr_{0.25}Nd_{0.75})ₓTM′_{y}Fe_{100%-x-y-z}B_{z}(II), where TM′ includes but not limited to one or more of elements Al, Cu, Co, Ga, Nb, Zr and Ti, x is 35% to 45%, y is 0.5% to 9%, and z is 0.5% to 0.9%. Compared with a modified sintered NdFeB permanent magnetic material having a single alloy component, the modified sintered NdFeB permanent magnetic material encompasses both the first alloy having specific components (having the value ranges of a, b, c to d strictly controlled) and the second alloy having specific components (having the value ranges of x, y to z strictly controlled), so as to exert a synergistic effect of the first alloy and the second alloy and to realize magnetic coupling isolation, thereby enhancing the coercive force and further improving the magnetic property. Moreover, the absolute value of the temperature coefficient of the intrinsic coercive force of the modified sintered NdFeB permanent magnetic material is further reduced, so that comprehensive properties such as the high-temperature resistance and the maximum magnetic energy product of the modified sintered NdFeB permanent magnetic material are further improved. Compared with other types of TM′, using TM′ of the preferred type described above, in one aspect, a microstructure, a grain structure, and a grain boundary phase distribution of the material may be improved, and the intrinsic coercive force of the material may be better improved without reducing the residual magnetism of the material. In another aspect, sintering characteristic of the material may be improved, and a compact magnet having uniform grains may be obtained in a certain temperature range, thereby facilitating preparation of the modified sintered NdFeB permanent magnetic material.

In order to further exert the synergistic effect of the first alloy and the second alloy and to further improve the comprehensive properties such as the magnetic property and the high-temperature resistance of the modified sintered NdFeB permanent magnetic material, preferably, x is 38% to 42%, y is 1.6% to 4.5%, and z is 0.6% to 0.8%.

In a preferred embodiment, by a total weight of the first alloy and the second alloy, a weight percentage of the second alloy is no more than 30 wt %. When a weight percentage of the second alloy is over 30 wt %, in one aspect, the second alloy will make less contribution to both an improvement effect on the grain boundary phase distribution of the modified sintered NdFeB material and an enhancement effect on the intrinsic coercive force. In another aspect, a too high content of the rare earth elements and a too low content of B in the components of the material will affect the sintering characteristic of the material, resulting in the reduction of the residual magnetism and magnetic energy product of the modified sintered NdFeB permanent magnetic material. A weight percentage of a second alloy is limited within the range described above, so as to exert the synergistic effect of the first alloy and the second alloy, to further improve the high-temperature resistance of the modified sintered NdFeB permanent magnetic material, to further reduce the cost, and to maintain the magnetic property at a high level.

In a preferred embodiment, LRE is Gd and Ce, or Gd and Y, or Gd, Y, and Ce. Compared with other types, the element Nd is replaced with the specific type of the LRE element described above. Therefore, in one aspect, the cost of the modified sintered NdFeB permanent magnetic material is greatly reduced. In another aspect, the magnetic property is maintained at a high level while the high-temperature resistance of the material is improved.

In order to improve the magnetic property and the high-temperature resistance while the cost of the modified sintered NdFeB permanent magnetic material is further reduced, preferably, LRE is Gd and Ce; and more preferably, LRE is Gd and Ce, a weight ratio of Gd to Ce is (13-18):(8-10), further more preferably (13-15):(8-10).

In a preferred embodiment, TM′ is a combination of Co, Cu, and Zr, or a combination of Al, Co, Cu, and Zr, or a combination of Al, Co, Ga, and Zr, or a combination of Al, Cu, Ga, and Zr, or a combination of Al, Co, Cu, Ga, and Zr. Compared with other types, by doping the specific type of the TM′ element, in one aspect, the cost of the modified sintered NdFeB permanent magnetic material is reduced; in another aspect, the magnetic property and the high-temperature resistance of the material are improved.

In order to improve the magnetic property and the high-temperature resistance while the cost of the modified sintered NdFeB permanent magnetic material is further reduced, preferably, TM′ is a combination of Al, Co, Cu, Ga, and Zr; more preferably, TM′ is a combination of Al, Co, Cu, Ga, and Zr, a weight ratio of Al to Co to Cu to Ga to Zr is (0-3):(0.2-1.5):(0.1-0.5):(0-0.3):(0.1-0.16), further more preferably (0.2-1.5):(0.2-1.0):(0.1-0.3):(0.1-0.3):(0.1-0.16).

In a preferred embodiment, TM is a combination of Al, Co, Cu, Ga and Zr, or a combination of Al, Co, Cu, Ga and Nb, or a combination of Al, Co, Cu, Ga and Ti. Compared with other types, the TM element of the specific type described above is doped. Therefore, in one aspect, the cost of the modified sintered NdFeB permanent magnetic material is reduced; in another aspect, the magnetic property and the high-temperature resistance of the material are improved.

In order to improve the magnetic property and the high-temperature resistance while the cost of the modified sintered NdFeB permanent magnetic material is further reduced, preferably, TM is a combination of Al, Co, Cu, Ga, and Zr; and more preferably, TM is a combination of Al, Co, Cu, Ga, and Zr, a weight ratio of Al, Co, Cu, Ga to Zr is (0.2-3):(0.2-1.5):(0.1-0.5):(0.1-0.3):(0.1-0.16), further more preferably (0.2-1.5):(0.2-1.0):(0.1-0.3):(0.1-0.3):(0.1-0.16).

In another preferred embodiment, TM is a combination of Al, Co, Cu, Ga, Nb, and Zr, or a combination of Al, Co, Cu, Ga, Zr, and Ti. Compared with other types, by doping the specific type described above of the TM element, in one aspect, the cost of the modified sintered NdFeB permanent magnetic material is reduced; in another aspect, the magnetic property and the high-temperature resistance of the material are improved.

Preferably, TM is a combination of Al, Co, Cu, Ga, Zr, and Ti; preferably, TM is a combination of Al, Co, Cu, Ga, Zr, and Ti, a weight ratio of Al, Co, Cu, Ga, Zr to Ti is (0.2-3):(0.2-1.5):(0.1-0.5):(0.1-0.3):(0.04-0.16):(0.05-0.2), further more preferably (0.2-1.5):(0.2-1.0):(0.1-0.3):(0.1-0.3):(0.04-0.12):(0.05-0.15).

In a preferred embodiment, a weight ratio of the first alloy to the second alloy is (80-90):(10-20). The weight ratio of the first alloy to the second alloy includes but is not limited to the range described above. The weight ratio is limited within the range described, so as to further exert the synergistic effect of the first alloy and the second alloy, to further improve the high-temperature resistance of the modified sintered NdFeB permanent magnetic material, and to further reduce the cost.

In a second aspect, the disclosure provides a preparation method for the above-described modified sintered NdFeB permanent magnetic material provided by the disclosure. The preparation method for the modified sintered NdFeB permanent magnetic material includes: a Pr—Nd alloy, an LRE source and a TM source are mixed with ferroboron, and a first smelting treatment and first strip casting treatment are performed to obtain a first alloy flakes; where the LRE source includes but is not limited to one or more of a Gd—Fe alloy, a Y elementary substance, and a Ce elementary substance; the TM source includes but is not limited to one or more of a Al elementary substance, a Cu elementary substance, a Co elementary substance, a Ga elementary substance, a Nb—Fe alloy, a Zr elementary substance, and a Ti elementary substance; a crushing treatment is performed on the first alloy flakes to obtain a first powder; a orientation forming and a pressing treatment is performed on the first powder to obtain a green body; and sintering treatment and tempering treatment is performed on the green body to obtain the modified sintered NdFeB permanent magnetic material.

The first smelting treatment is performed on raw materials described above, so as to perform the first subsequent strip casting treatment to obtain the first alloy flakes. The crushing treatment is performed on the first alloy flakes, so as to crush and refine the first alloy flakes into the first powder having a small particle size, facilitating the subsequent orientation forming treatment. The orientation forming treatment is to make the first powder overcome a friction force and the agglomeration between powder particles under the action of an external magnetic field, so as to form the first powder having an orientation degree. The pressing treatment is to make the first powder compacted and shaped through pressure, thereby obtaining the green body. The orientation forming and pressing treatment is performed on the first powder to obtain the green body. The sintering treatment and the tempering treatment are performed on the green body to obtain the modified sintered NdFeB permanent magnetic material.

In order to further improve an effect of the crushing treatment and to obtain a powder having a more uniform particle size, in a preferred embodiment, a weight ratio of the first powder, the antioxidant to the lubricant is 100:(0.05-0.2):(0.03-0.15). Preferably, a mean particle size of the first powder includes but is not limited to 3.0 μm to 3.8 μm.

In a preferred embodiment, the preparation method for the modified sintered NdFeB permanent magnetic material further includes: a Pr—Nd alloy and a TM′ source are mixed with ferroboron, and a second smelting treatment and a second strip casting treatment are performed to obtain a second alloy flakes; where the TM′ source includes but is not limited to one or more of a Al elementary substance, a Cu elementary substance, a Co elementary substance, a Ga elementary substance, a Nb—Fe alloy, a Zr elementary substance, and a Ti elementary substance; the second alloy flakes is added during the crushing treatment to perform the crushing treatment on the first alloy flakes and the second alloy flakes, so as to obtain a second powder; and the second powder is mixed with a lubricant before orientation forming. By employing the treatment method described above, the modified sintered NdFeB permanent magnetic material having a more uniform grain boundary phase distribution may be obtained, and magnetic coupling isolation may be realized, thereby effectively enhancing the coercive force and improving the high-temperature resistance. After the second powder is mixed with the lubricant, the orientation forming treatment is performed, so that a friction force between particles of the second powder may be reduced, thereby facilitating processing and improving the orientation degree of the material.

The hydrogen decrepitation treatment maybe divided into two stages of hydrogen absorption and dehydrogenation, a principle of which is to generate a hydrogenation reaction between hydrogen and a Nd-rich phase as well as a main phase. The crisp powder may be obtained after the hydrogen decrepitation treatment, which is conducive to further fine crushing. Jet-milling is a process in which powder particles subjected to the hydrogen decrepitation treatment are accelerated to a supersonic speed through high-pressure gas flow, so as to collide with one another to be crushed. In a preferred embodiment, the crushing treatment sequentially includes a hydrogen decrepitation treatment and a jet-milling, where an antioxidant is added during the jet-milling, and the second powder is obtained after the jet-milling. The antioxidant is added during the jet-milling, so that the first powder and the second powder are inhibited from being oxidized by oxidizing substances such as oxygen in an environment, thereby avoiding the situation that owing to oxidation, the property is suddenly reduced.

In order to further improve the effect of the crushing treatment and obtain a powder having a more uniform particle size, in a preferred embodiment, a weight ratio of a total weight of the first powder and the second powder, the antioxidant to the lubricant is 100:(0.05-0.2):(0.03-0.15). Preferably, each of mean particle sizes of the first powder and the second powder includes but is not limited to 3.0 μm to 3.8 μm.

The antioxidant employed in the disclosure includes but is not limited to one or more of Dongyang Antai YKJ-10, Tianjin Yuesheng YSH-01, and Ningbo Haotian HT-3. The lubricant employed in the disclosure includes but is not limited to one or more of Ningbo Haotian HT-3 and Tianjin Yuesheng YSH-06.

In a preferred embodiment, each of temperatures of the first smelting treatment and the second smelting treatment includes but is not limited to 1450° C. to 1520° C. The temperatures of the first smelting treatment and the second smelting treatment includes but are not limited to the range described above, so as to improve crystal form uniformity of the first alloy flakes and the second alloy flakes subsequently formed, thereby improving the magnetic property and the high-temperature resistance of the subsequently prepared modified sintered NdFeB permanent magnetic material, and further controlling the (BH) max of the prepared modified sintered NdFeB permanent magnetic material within the range of 5 MGOe to 30 MGOe. The temperature of the first smelting treatment may be 1450° C., 1480° C., 1490° C., 1520° C., etc.; and the temperature of the second smelting treatment may be 1450° C., 1470° C., 1520° C., etc.

In a preferred embodiment, an orientation forming process is performed in an environment having an oxygen content no more than 0.01%. The oxygen content in the orientation forming process is limited within the range described above, so as to inhibit the raw materials from being oxidized by oxygen in the environment and to inhibit adverse effects on the magnetic property and the high-temperature resistance of the modified sintered NdFeB permanent magnetic material.

In a preferred embodiment, the pressing treatment is cold isostatic pressing treatment, of which a pressure and a time are 180 MPa to 200 MPa and 60 s to 120 s, respectively.

In a preferred embodiment, a temperature, a time, and a vacuum degree of a sintering treatment process are 1000° C. to 1060° C., 2 h to 10 h, and no more than 5×10−2 Pa, respectively. The temperature and time of the sintering treatment process include but are not limited to the ranges described above. The temperature and time are limited within the ranges described above, so as to further reduce the absolute value of the temperature coefficient of the intrinsic coercive force of the modified sintered NdFeB permanent magnetic material, thereby further improving the high-temperature resistance of the material.

In order to further reduce the absolute value of the temperature coefficient of the intrinsic coercive force and to further improve the high-temperature resistance of the material, preferably, a temperature, a time, and a vacuum degree of the sintering treatment process are 1030° C. to 1050° C., 4 h to 8 h, and lower than 5×10−2 Pa, respectively.

In a preferred embodiment, a tempering treatment process is staged tempering treatment, including first-stage tempering treatment and second-stage tempering treatment. A temperature and a time of the first-stage tempering treatment are 850° C. to 950° C. and 1 h to 3 h, respectively. A temperature and a time of the second-stage tempering treatment are 480° C. to 600° C. and 3 h to 6 h, respectively. In the tempering treatment process, the temperature and the time of the first tempering treatment and the temperature and the time of the second tempering treatment include, but are not limited to, the ranges described above, respectively. The temperatures and the times are limited within the ranges described above, so as to further reduce the absolute value of the temperature coefficient of intrinsic coercive force of the modified sintered NdFeB permanent magnetic material, thereby further improving the high-temperature resistance of the material.

The disclosure will be further described in detail below with reference to specific examples, which should not be interpreted as limiting the scope of protection claimed by the disclosure.

### Example 1

A preparation method for a modified sintered NdFeB permanent magnetic material included:

A Pr—Nd alloy, a Gd—Fe alloy, a Ce elementary substance, a Al elementary substance, a Co elementary substance, a Cu elementary substance, a Ga elementary substance and a Zr elementary substance were mixed with ferroboron, and a first smelting treatment was performed, where a temperature of the first smelting treatment was 1490° C. The first strip casting treatment was performed to obtain a first alloy flakes with a thickness of 0.2 mm to 0.4 mm, where the flakess having a thickness of 0.25 mm to 0.35 mm account for over 90%.

A hydrogen decrepitation treatment was performed on the above-described first alloy flakes prepared. An antioxidant (Dongyang Antai YKJ-10) was added for mixing, a resulting mixture was stirred for 40 min, and a jet-milling was performed to prepare a powder. Then a lubricant (Tianjin Yuesheng YSH-06) was added, and a resulting mixture was stirred for 60 min to obtain a first powder with a mean particle size of 3.4 μm. A weight ratio of the first powder, the antioxidant to the lubricant was 100:0.1:0.08.

The first powder described above was formed in a forming press with an oxygen content less than 0.01% to obtain a pressed blank having a density of 3.75 g/cm³. Then a cold isostatic pressing treatment was performed to obtain a green body having a density of 4.4 g/cm³. A pressure and a time of the cold isostatic pressing treatment were 180 MPa and 120 s, respectively.

The prepared green body described above was transferred into a sintering furnace for sintering treatment, and the sintering furnace was vacuumized to <5×10⁻² Pa. A temperature and a time of the sintering treatment were 1030° C. and 4.5 h, respectively. Then staged tempering treatment was performed, where a temperature and a time of a first-stage tempering treatment were 890° C. and 2 h, respectively; and a temperature and a time of a second-stage tempering treatment were 540° C. and 5 h, respectively. Finally the modified sintered NdFeB permanent magnetic material was obtained.

The modified sintered NdFeB permanent magnetic material prepared in the example was composed of a first alloy. The first alloy was (Pr_{0.25}Nd_{0.75})₅Gd₁₈Ce₁₀Fe_{62.51}Al₃CO_{0.2}Cu_{0.1}Ga_{0.1}Zr_{0.13}B_{0.96}, where a was 5%, b was 28%, c was 3.53%, and d was 0.96%.

### Example 2

The differences from Example 1 were that a usage amount ratio of a Pr—Nd alloy, a Gd—Fe alloy, a Ce elementary substance, a Al elementary substance, a Co elementary substance, a Cu elementary substance, a Ga elementary substance to a Zr elementary substance to ferroboron was changed; and a temperature of first smelting treatment was 1480° C., and a mean particle size of a first powder obtained was 3.3 μm.

A modified sintered NdFeB permanent magnetic material finally prepared in the example was composed of a first alloy. The first alloy was (Pr_{0.25}Nd_{0.75})_{6.5}Gd₁₆Ce₁₀Fe_{63.31}Al₂Co_{0.5}Cu_{0.3}Ga_{0.3}Zr_{0.13}B_{0.96}, where a was 6.5%, b was 26%, c was 3.23%, and d was 0.96%.

### Example 3

The differences from Example 1 were that a use amount ratio of a Pr—Nd alloy, a Gd—Fe alloy, a Ce elementary substance, a Al elementary substance, a Co elementary substance, a Cu elementary substance, a Ga elementary substance to a Zr elementary substance to ferroboron was changed; and a temperature of first smelting treatment was 1480° C.

A modified sintered NdFeB permanent magnetic material finally prepared in the example was composed of a first alloy. The first alloy was (Pr_{0.25}Nd_{0.75})_{7.5}Gd₁₅Ce₁₀Fe_{63.41}Al_{1.5}Co₁Cu_{0.3}Ga_{0.2}Zr_{0.13}B_{0.96}, where a was 7.5%, b was 25%, c was 3.13%, and d was 0.96%.

### Example 4

A preparation method for a modified sintered NdFeB permanent magnetic material includes:

A Pr—Nd alloy, a Gd—Fe alloy, a Ce elementary substance, a Al elementary substance, a Co elementary substance, a Cu elementary substance, a Ga elementary substance and a Zr elementary substance were mixed with ferroboron, and a first smelting treatment was performed, where a temperature of the first smelting treatment was 1480° C. A first strip casting treatment was performed to obtain a first alloy flakes with a thickness of 0.2 mm to 0.4 mm, where the flakess having a thickness of 0.25 mm to 0.35 mm account for over 90%.

A Pr—Nd alloy, a Ce elementary substance, a Al elementary substance, a Co elementary substance, a Cu elementary substance, a Ga elementary substance and a Zr elementary substance were mixed with ferroboron, and second smelting treatment was performed, where a temperature of the second smelting treatment was 1450° C. Second strip casting treatment was performed to obtain a second alloy flakes having a thickness of 0.2 mm to 0.4 mm, where the flakess having a thmm account for over 90%.

The above-described first alloy flakes and second alloy flakes prepared were mixed, and hydrogen decrepitation treatment and jet-milling were sequentially performed. An antioxidant (Dongyang Antai YKJ-10) was added for mixing during jet-milling, and a resulting mixture was stirred for 40 min. Lubricants (Tianjin Yuesheng YSH-01 and YSH-06) were added, and a resulting mixture was stirred for 60 min to obtain a second powder having a mean particle size of 3.3 μm. A weight ratio of a first powder to a second powder to the antioxidant to the lubricant was 90:10:0.1:0.11, where a weight ratio of the lubricant YSH-01 to the lubricant YSH-06 was 0.03:0.08.

The second powder described above was formed in a forming press having an oxygen content less than 0.01% to obtain a pressed blank having a density of 3.8 g/cm³. Then cold isostatic pressing treatment was performed to obtain a green body having a density of 4.45 g/cm³. A pressure and a time of the cold isostatic pressing treatment were 180 MPa and 120 s, respectively.

The prepared green body described above was transferred into a sintering furnace for sintering treatment, and the sintering furnace was vacuumized to <5×10⁻² Pa. A temperature and a time of the sintering treatment were 1045° C. and 4.5 h, respectively. Then staged tempering treatment was performed, where a temperature and a time of first-stage tempering treatment were 890° C. and 2 h, respectively; and a temperature and a time of second-stage tempering treatment were 550° C. and 5 h, respectively. Finally the modified sintered NdFeB permanent magnetic material was obtained.

Compared with Example 1, the modified sintered NdFeB permanent magnetic material prepared in Example 4 had different components of a first alloy, and a second alloy was also introduced. The modified sintered NdFeB permanent magnetic material was composed of the first alloy and the second alloy. Specifically, the first alloy was (Pr_{0.25}Nd_{0.75})_{6.5}Gd₁₅Ce₁₀Fe_{65.96}Al₁Co_{0.2}Cu_{0.1}Ga_{0.1}Zr_{0.16}B_{0.98}, where a was 6.5%, b was 25%, c was 1.56%, and d was 0.98%, and the second alloy was (Pr_{0.25}Nd_{0.75})₄₀Fe_{55.7}Al_{1.5}Co_{0.2}Cu_{0.5}Ga_{0.5}Zr_{0.1}B_{0.7}, where x was 40%, y was 2.8%, and z was 0.7%.

### Example 5

A second alloy had the same components as that in Example 4. The differences from Example 4 were that a use amount ratio of a Pr—Nd alloy, a Gd—Fe alloy, a Ce elementary substance, a Al elementary substance, a Co elementary substance, a Cu elementary substance, a Ga elementary substance to a Zr elementary substance to ferroboron was changed, so that a first alloy in a modified sintered NdFeB permanent magnetic material finally prepared was (Pr_{0.25}Nd_{0.75})₉Gd₁₄Ce₉Fe_{66.96}Al_{0.5}Co_{0.2}Cu_{0.1}Ga_{0.1}Zr_{0.16}B_{0.98}, where a was 8%, b was 23%, c was 1.06%, and d was 0.98%; a temperature of second smelting treatment was 1470° C., and a weight ratio of a first powder to a second powder to an antioxidant to a lubricant was 85:15:0.1:1.1.

### Example 6

A second alloy has the same components as that in Example 4. The differences from Example 4 were that a use amount ratio of a Pr—Nd alloy, a Gd—Fe alloy, a Ce elementary substance, a Al elementary substance, a Co elementary substance, a Cu elementary substance, a Ga elementary substance to a Zr elementary substance to ferroboron was changed, so that a first alloy in a modified sintered NdFeB permanent magnetic material finally prepared was (Pr_{0.25}Nd_{0.75})₉Gd₁₃Ce₈Fe_{67.66}Al_{0.2}Co_{0.5}Cu_{0.2}Ga_{0.3}Zr_{0.16}B_{0.98}, where a was 9%, b was 21%, c was 1.36%, and d was 0.98%; and a temperature of second smelting treatment was 1490° C., a weight ratio of a first powder to a second powder to an antioxidant to a lubricant was 80:20:0.1:1.1, and a temperature of sintering treatment was 1050° C.

### Example 7

The differences from Example 1 were that objects of the first smelting treatment were different, that was, a use amount ratio of a Pr—Nd alloy, a Gd—Fe alloy, a Ce elementary substance, a Co elementary substance, a Cu elementary substance, a Ti elementary substance to ferroboron was changed, so that a first alloy in a modified sintered NdFeB permanent magnetic material finally prepared was (Pr_{0.25}Nd_{0.75})₂₀Gd₁₀Ce₃Fe_{65.7}Co_{0.2}Cu_{0.1} Ti_{0.1}B_{0.9}, where a was 20%, b was 13%, c was 0.4%, and d was 0.9%.

### Example 8

The differences from Example 1 were that objects of the first smelting treatment were different, that was, a use amount ratio of a Pr—Nd alloy, a Gd—Fe alloy, a Ce elementary substance, a Al elementary substance, a Co elementary substance, a Cu elementary substance, a Ga elementary substance, a Ti elementary substance to ferroboron was changed, so that a first alloy in a modified sintered NdFeB permanent magnetic material finally prepared was (Pr_{0.25}Nd_{0.75})₅Gd₁₈Ce₁₀Fe_{60.5}Al₃Co_{1.3}Cu_{0.5}Ga_{0.3} Ti_{0.2}B₁, where a was 5%, b was 28%, e was 5.5%, and d was 1%.

### Example 9

The differences from Example 1 were that objects of the first smelting treatment were different, that was, a use amount ratio of a Pr—Nd alloy, a Gd—Fe alloy, a Ce elementary substance, a Y elementary substance, a Al elementary substance, a Co elementary substance, a Cu elementary substance, a Ga elementary substance, a Zr elementary substance to ferroboron was changed, so that a first alloy in a modified sintered NdFeB permanent magnetic material finally prepared was (Pr_{0.25}Nd_{0.75})₅Gd₁₃Ce₁₀Y5Fe_{62.51}Al₃Co_{0.2}Cu_{0.1}Ga_{0.1}Zr_{0.13}B_{0.96}, where LRE includes elements Gd, Ce, and Y, and a, b, c, and d were the same as those in Example 1, respectively.

### Example 10

A first alloy had the same components as that in Example 4. The differences from example 4 were that objects of second smelting treatment were different, that was, a use amount ratio of a Pr—Nd alloy, a Al elementary substance, a Co elementary substance, a Cu elementary substance, a Ga elementary substance, a Ti elementary substance to ferroboron was changed, so that a component of a second alloy in a modified sintered NdFeB permanent magnetic material finally prepared was (Pr_{0.25}Nd_{0.75})₃₅Fe_{56.1}Al₂Co₂Cu_{1.5}Ga_{1.5} Ti₁B_{0.9}, where x was 35%, y was 8%, and z was 0.9%.

### Example 11

The differences from example 4 were that:

Objects of the first smelting treatment were different, that was, only a use amount ratio of a Al elementary substance, a Co elementary substance, a Cu elementary substance, a Zr elementary substance, a Ti elementary substance was changed, and other raw materials were unchanged. A use amount ratio of Al, Co, Cu, Zr to Ti in a first alloy in a modified sintered NdFeB permanent magnetic material finally prepared was different, a component of the first alloy was (Pr_{0.25}Nd_{0.75})_{6.5}Gd₁₅Ce₁₀Fe_{65.96}Al₁Co_{0.2}Cu_{0.2}Zr_{0.06} Ti_{0.1}B_{0.98}, where a, b, c, and d were the same as those in Example 1, respectively.

Objects of the second smelting treatment were different, that was, a Pr—Nd alloy, a Cu elementary substance and a Ti elementary substance were mixed with ferroboron, and the second smelting treatment was performed, where TM′ was a combination of the elements Cu and Ti, so that a component of a second alloy in a modified sintered NdFeB permanent magnetic material finally prepared was (Pr_{0.25}Nd_{0.75})₄₅Fe₅₄Cu_{0.3} Ti_{0.2}B_{0.5}, where TM′ was a combination of the elements Cu and Ti, x was 45%, y was 0.5%, and z was 0.5%.

### Example 12

The differences from Example 4 were that:

Objects of the first smelting treatment were different, that was, only a Zr elementary substance in raw materials was replaced with a Ti elementary substance in the same amount, and a use amount ratio of the raw materials was unchanged, so that a component of a first alloy in a modified sintered NdFeB permanent magnetic material finally prepared was (Pr_{0.25}Nd_{0.75})_{6.5}Gd₁₅Ce₁₀Fe_{65.96}Al₁Co_{0.2}Cu_{0.1}Ga_{0.1} Ti_{0.16}B_{0.98}, where TM was a combination of elements Al, Co, Cu, Ga, and Ti, and a, b, c, and d were the same as those in Example 4, respectively.

Objects of the second smelting treatment were different, that was, a Pr—Nd alloy and a Co elementary substance were mixed with ferroboron, and the second smelting treatment was performed, and a use amount ratio of the Pr—Nd alloy, the Co elementary substance to the ferroboron was changed, so that a component of a second alloy in a modified sintered NdFeB permanent magnetic material finally prepared was (Pr_{0.25}Nd_{0.75})₅₀Fe_{48.8}Co_{0.2}B₁, where TM′ includes the element Co only, x was 50%, y was 0.2%, and z was 1%.

### Example 13

The difference from Example 4 was that a weight ratio of a first alloy flakes to a second alloy flakes in a crushing treatment process was changed, so that a weight ratio of a first alloy to a second alloy in a prepared modified sintered NdFeB permanent magnetic material was 70:30.

### Example 14

The difference from Example 4 was that a weight ratio of a first alloy flakes to a second alloy flakes in a crushing treatment process was changed, so that a weight ratio of a first alloy to a second alloy in a prepared modified sintered NdFeB permanent magnetic material was 60:40.

### Example 15

The differences from example 4 were that a temperature of the first alloy smelting treatment was 1350° C. and a temperature of the second alloy smelting treatment was 1550° C.

### Comparative Example 1

The difference from Example 1 was that a magnetic performance test was performed on a traditional sintered NdFeB permanent magnetic material, where the sintered NdFeB permanent magnetic material had a component of (PrNd)₃₂Fe_{66.49}Co_{0.2}Cu_{0.2}Zr_{0.15}B_{0.96}, and was prepared as follows:

A Pr—Nd alloy, a Co elementary substance, a Cu elementary substance and a Zr elementary substance were mixed with ferroboron, and a first smelting treatment was performed, where a temperature of the first smelting treatment was 1500° C. First strip casting treatment was performed to obtain an alloy flakes having a thickness of 0.2 mm to 0.4 mm, where the flakess having a thickness of 0.25 mm to 0.35 mm account for over 90%.

A hydrogen decrepitation treatment and a jet-milling were sequentially performed on the first prepared alloy flakes described above. An antioxidant (Dongyang Antai YKJ-10) was added for mixing before a jet-milling, and a resulting mixture was stirred for 40 min. A lubricant (Tianjin Yuesheng YSH-06) was added for mixing after the jet-milling, and a resulting mixture was stirred for 60 min to obtain a first powder having a mean particle size of 3.2 μm. A weight ratio of the first powder, the antioxidant to the lubricant was 100:0.1:0.08.

The powder described above was formed in a forming press having an oxygen content less than 0.01% to obtain a pressed blank having a density of 3.75 g/cm³. Then cold isostatic pressing treatment was performed to obtain a green body having a density of 4.4 g/cm³. A pressure and a time of the cold isostatic pressing treatment were 180 MPa and 120 s, respectively.

The prepared green body described above was transferred into a sintering furnace for sintering treatment, and the sintering furnace was vacuumized to <5×10⁻² Pa. A temperature and a time of the sintering treatment were 1075° C. and 4.5 h, respectively. Then staged tempering treatment was performed: a temperature and a time of a first-stage tempering treatment were 920° C. and 2 h, respectively; and a temperature and a time of a second-stage tempering treatment were 520° C. and 5 h, respectively. Finally the sintered NdFeB permanent magnetic material was obtained.

### Comparative Example 2

The differences from Comparative Example 1 were that objects of first smelting treatment were different, that is, a Pr—Nd alloy, a Dy—Fe alloy, a Al elementary substance, a Co elementary substance, a Cu elementary substance, a Ga elementary substance and a Ti elementary substance were mixed with ferroboron, the first smelting treatment was performed, and a use amount ratio of the raw materials described above was changed, so that a component of a sintered NdFeB material finally prepared was (Pr_{0.25}Nd_{0.75})₂₇Dy₄Fe_{65.33}Al_{0.8}Co₁Cu_{0.4}Ga_{0.4}Ti_{0.16}B_{0.91}, where LRE includes the element Dy only, and TM was a combination of the elements Al, Co, Cu, Ga, and Ti.

### Comparative Example 3

The differences from Comparative Example 1 were that objects of first smelting treatment were different, that is, raw materials exclude a Gd—Fe alloy. A component of a sintered NdFeB material finally prepared was (Pr_{0.25}Nd_{0.75})₅Ce₂₈Fe_{62.59}Al₃Co_{0.2}Cu_{0.1}Zr_{0.15}B_{0.96}, without the element Gd.

### Comparative Example 4

The differences from Example 1 were that objects of first smelting treatment were different, and a use amount of each raw material was different, so that a component of a first alloy in a modified sintered NdFeB permanent magnetic material finally prepared was (Pr_{0.25}Nd_{0.75})₃Gd₃₀Fe_{62.35}Co_{0.2}Zr_{0.15}B_{1.1}, where a was 3%, b was 30%, c was 0.35%, and d was 1.1%.

The magnetic properties of the modified sintered NdFeB permanent magnetic materials prepared in all the examples and comparative examples of the disclosure were tested at a room temperature (20° C.) and a high temperature (120° C.) separately through a permanent magnetic material test B-H instrument NIM-2000, and a temperature were coefficient of residual magnetism Br and a temperature coefficient of intrinsic coercive force Hcj calculated. A formula for calculating the temperature coefficient of residual magnetism Br is α=(Br₁−Br₀)/(100Br₀)×100%, where Br1 and Br0 are residual magnetism of the modified sintered NdFeB permanent magnetic material measured at 120° C. and 20° C., respectively. A formula for calculating the temperature coefficient of intrinsic coercive force Hcj is β=(Hcj₁−Hcj₀)/(100Hcj₀)×100%, where Hcj₁ and Hcj₀ are intrinsic coercive forces of the modified sintered NdFeB permanent magnetic material measured at 120° C. and 20° C., respectively.

Test results are shown in Table 1. The modified sintered NdFeB permanent magnetic material has a negative temperature coefficient, of which a magnetization intensity and the intrinsic coercive force are decreased along with the increase in temperature. Therefore, data in Table 1 are negative.

TABLE 1

| | | | | α(Br)/ | β(Hcj)/ |
|---|---|---|---|---|---|
| | Br/ | Hcj/ | (BH)max/ | (%/° | (%/° |
| | kGs | kOe | MGOe | C.) | C.) |
| Example 1 | 6.65 | 9.176 | 10.64 | −0.1173 | −0.6801 |
| Example 2 | 7.58 | 10.452 | 13.46 | −0.1083 | −0.5742 |
| Example 3 | 8.21 | 9.636 | 15.92 | −0.1028 | −0.4316 |
| Example 4 | 9.02 | 9.400 | 19.28 | −0.1056 | −0.4675 |
| Example 5 | 9.64 | 9.250 | 22.52 | −0.1063 | −0.4845 |
| Example 6 | 10.26 | 9.890 | 25.64 | −0.1058 | −0.4781 |
| Example 7 | 10.74 | 10.586 | 28.98 | −0.1054 | −0.4853 |
| Example 8 | 6.32 | 9.522 | 9.84 | −0.1158 | −0.6741 |
| Example 9 | 7.67 | 5.28 | 13.89 | −0.1325 | −0.7588 |
| Example 10 | 9.14 | 9.650 | 19.65 | −0.1061 | −0.4686 |
| Example 11 | 9.09 | 9.180 | 19.48 | −0.1067 | −0.4662 |
| Example 12 | 8.83 | 8.75 | 18.89 | −0.1112 | −0.4922 |
| Example 13 | 9.43 | 10.870 | 22.04 | −0.1054 | −0.4831 |
| Example 14 | 8.42 | 9.670 | 15.44 | −0.1087 | −0.5335 |
| Example 15 | 8.55 | 7.640 | 17.88 | −0.1154 | −0.5458 |
| Comparative Example 1 | 14.24 | 12.58 | 50.56 | −0.1286 | −0.7247 |
| Comparative Example 2 | 11.96 | 26.34 | 34.21 | −0.1103 | −0.5366 |
| Comparative Example 3 | 6.87 | 1.596 | 10.96 | −0.1387 | −0.8336 |
| Comparative Example 4 | 7.96 | 3.225 | 14.63 | −0.0945 | −0.3872 |

It can be seen from the above description that the examples described above of the disclosure realize the technical effects as follows:

By comparing Example 1 with Comparative Examples 1 to 4, it can be seen that elements Pr and Nd in the traditional sintered NdFeB permanent magnetic material ((PrNd)—Fe—B) are replaced with rare earth elements (such as Gd, Y, and Ce) of specific types and use amounts. In one aspect, the modified sintered NdFeB permanent magnetic material having the maximum magnetic energy product (BH) max in the range of 5 MGOe to 30 MGOe and the magnetic property (residual magnetism Br is 6 kGs to 11 kGs, and an intrinsic coercive force Hcj is 5 kOe to 11 kOe) satisfying the demands of low-end fields may be obtained. In another aspect, the temperature coefficient of the intrinsic coercive force may be improved under the combined action of the rare earth element of the specific type and the TM element in a specific weight ratio (with the value ranges of a, b, c to d strictly controlled) of the disclosure, so that the high-temperature resistance of the material is improved, and the material may be applied under a high-temperature condition.

By comparing Examples 2 to 7 and 10 to 14 with Comparative Examples 1 and 2, it can be seen that the elements Pr and Nd in the sintered NdFeB permanent magnetic material are replaced with the rare earth elements Gd and Ce of the specific types, and the TM element in a specific ratio is employed. While the obtained material has Hcj (6 kOe to 11 kOe) much lower than a conventional sintered NdFeB material, the temperature coefficient of the residual magnetism and the intrinsic coercive force of the obtained material are better than those of a N-brand (having Hcj between 12 kOe to 14 kOe) sintered NdFeB permanent magnetic material, and close to or even superior to those of a UH-brand (having Hcj between 25 kOe to 30 kOe) sintered NdFeB permanent magnetic material. Therefore, the modified sintered NdFeB material of the disclosure may satisfy the demands of high-temperature application within 150° C.

By comparing Examples 1, 7, and 8 with Comparative Example 4, it can be seen that a content of the element Gd in the first alloy of the modified sintered NdFeB permanent magnetic material prepared in Comparative Example 4 is extremely high (up to 30%), while contents of the element Gd in Examples 1, 7, and 8 are within the preferred range of the disclosure. With reference to the property results measured in Comparative Example 4 in Table 1, while the high-temperature resistance in Comparative Example 4 is slightly improved compared with Examples 1, 7 and 8, the intrinsic coercive force Hcj in Comparative Example 4 is only 3.225 kOe (obviously lower than those in Examples 1, 7, and 8). Therefore, the material in Comparative Example 4 is poor in comprehensive property and not conducive to practical application. This shows that the high-temperature resistance of the prepared modified sintered NdFeB permanent magnetic material may be improved by limiting a, b, c, and d in the first alloy within the preferred ranges of the disclosure, respectively and employing LRE and the TM element of the preferred types of the disclosure.

By comparing Examples 1 and 9 with Comparative Examples 2 and 3, it can be seen that compared with other types of elements, the high-temperature resistance of the prepared modified sintered NdFeB permanent magnetic material may be improved by employing the LRE element of the preferred type of the disclosure. It can be seen from the property results measured in Comparative Example 2 in Table 1 that Comparative Example 2 satisfies the requirements of the high-property sintered NdFeB material, brand N35UH, and the property of the material is excellent. However, by comparing Example 1 with Comparative Example 2, it can be seen that the modified sintered NdFeB permanent magnetic material in Comparative Example 2 has a significantly higher preparation cost than Example 1. This shows that the high-temperature resistance may be improved, and the preparation cost is reduced by replacing the elements Pr and Nd in the traditional sintered NdFeB permanent magnetic material with the rare earth elements of the specific types and use amounts of the disclosure.

By comparing Examples 1 and 10 to 12, it can be seen that compared with the modified sintered NdFeB permanent magnetic material with a single alloy component, the modified sintered NdFeB permanent magnetic material encompasses both the first alloy and the second alloy, so as to exert the synergistic effect of the first alloy and the second alloy and to further improve the magnetic property. Moreover, the absolute value of the temperature coefficient of the intrinsic coercive force of the modified sintered NdFeB permanent magnetic material is further reduced, thereby further improving the high-temperature resistance of the material.

By comparing Examples 4, 13, and 14, it can be seen that compared with other ranges, the weight ratio of the first alloy to the second alloy is limited within the preferred range of the disclosure, so as to exert the synergistic effect of the first alloy and the second alloy efficiently, to further improve the high-temperature resistance of the modified sintered NdFeB permanent magnetic material, to further reduce the cost, and to maintain the magnetic property at a high level.

By comparing Examples 4 and 15, it can be seen that the temperatures of the first smelting treatment and the second smelting treatment include but are not limited to the preferred ranges of the disclosure. The temperatures are limited within the preferred ranges of the disclosure, so as to improve the crystal form uniformity of the first alloy flakes and the second alloy flakes subsequently formed, thereby improving the magnetic property and the high-temperature resistance of the subsequently prepared modified sintered NdFeB permanent magnetic material. Moreover, the (BH) max of the prepared modified sintered NdFeB permanent magnetic material is further controlled within the range of 5 MGOe to 30 MGOe.

It should be noted that the terms “first”, “second”, etc. in the description and claims of the disclosure are used for distinguishing between similar objects, instead of necessarily describing a specific sequence or a precedence order. It should be understood that terms used in this way can be interchanged where appropriate, so that the embodiments of the disclosure described herein can be implemented in other sequences than those described herein.

What are described above are merely the preferred examples of the disclosure, but are not intended to limit the disclosure. Those skilled in the art can make various modifications and variations to the disclosure. Any modifications, equivalent replacements, improvements, etc. made within the spirit and principles of the disclosure should all fall within the scope of protection of the disclosure.

1. A modified sintered neodymium-iron-boron permanent magnetic material, comprising first alloy, the first alloy represented by formula (I): (Pr_{0.25} Nd_{0.75})ₐ(LRE)_{b}TM_{c}Fe_{100%-a-b-c-d}B_{d} (I), wherein LRE is a rare earth element, selected from one or more of elements Gd, Y, and Ce, and at least including the element Gd, TM is selected from one or more of elements Al, Cu, Co, Ga, Nb, Zr, and Ti, a is 5% to 20%, b is 13% to 28%, c is 0.4% to 5.5%, and d is 0.9% to 1%.

2. The modified sintered neodymium-iron-boron permanent magnetic material according to claim 1, wherein a is 7% to 16%, b is 16% to 26%, c is 0.7% to 3.3%, and d is 0.92% to 0.98%.

3. The modified sintered neodymium-iron-boron permanent magnetic material according to claim 1, further comprising a second alloy, the second alloy represented by formula (II): (Pr_{0.25}Nd_{0.75})xTM′yFe100_{%-x-y-z}B_{z} (II), wherein TM′ is selected from one or more of elements Al, Cu, Co, Ga, Nb, Zr, and Ti, x is 35% to 45%, y is 0.5% to 9%, and z is 0.5% to 0.9%;
preferably, x is 38% to 42%, y is 1.6% to 4.5%, and z is 0.6% to 0.8%.

4. The modified sintered neodymium-iron-boron permanent magnetic material according to claim 3, wherein by a total weight of the first alloy and the second alloy, a weight percentage of the second alloy is no more than 30 wt %.

5. The modified sintered neodymium-iron-boron permanent magnetic material according to claim 4, wherein LRE is Gd and Ce, or Gd and Y, or Gd, Y, and Ce; preferably, LRE is Gd and Ce; and more preferably, LRE is Gd and Ce, a weight ratio of Gd to Ce is (13-18):(8-10), further more preferably (13-15):(8-10);
TM′ is a combination of Co, Cu, and Zr, or a combination of Al, Co, Cu, and Zr, or a combination of Al, Co, Ga, and Zr, or a combination of Al, Cu, Ga, and Zr, or a combination of Al, Co, Cu, Ga, and Zr; preferably, TM′ is a combination of Al, Co, Cu, Ga, and Zr; and more preferably, TM′ is a combination of Al, Co, Cu, Ga, and Zr, a weight ratio of Al, Co, Cu, Ga to Zr is (0-3):(0.2-1.5):(0.1-0.5):(0-0.3):(0.1-0.16), further more preferably (0.2-1.5):(0.2-1.0):(0.1-0.3):(0.1-0.3):(0.1-0.16);
TM is a combination of Al, Co, Cu, Ga, and Zr, or a combination of Al, Co, Cu, Ga, and Nb, or a combination of Al, Co, Cu, Ga, and Ti; preferably, TM is a combination of Al, Co, Cu, Ga, and Zr; and more preferably, TM is a combination of Al, Co, Cu, Ga, and Zr, a weight ratio of Al, Co, Cu, Ga to Zr is (0.2-3):(0.2-1.5):(0.1-0.5):(0.1-0.3):(0.1-0.16), further more preferably (0.2-1.5):(0.2-1.0):(0.1-0.3):(0.1-0.3):(0.1-0.16); and alternatively,
TM is a combination of Al, Co, Cu, Ga, Nb, and Zr, or a combination of Al, Co, Cu, Ga, Zr, and Ti; preferably, TM is a combination of Al, Co, Cu, Ga, Zr, and Ti; and more preferably, TM is a combination of Al, Co, Cu, Ga, Zr, and Ti, a weight ratio of Al, Co, Cu, Ga, Zr to Ti is (0.2-3):(0.2-1.5):(0.1-0.5):(0.1-0.3):(0.04-0.16):(0.05-0.2), further more preferably (0.2-1.5):(0.2-1.0):(0.1-0.3):(0.1-0.3):(0.04-0.12):(0.05-0.15).

6. The modified sintered neodymium-iron-boron permanent magnetic material according to claim 5, wherein a weight ratio of the first alloy to the second alloy is (80-90):(10-20).

7. A preparation method for the modified sintered neodymium-iron-boron permanent magnetic material according to claim 1, comprising:
mixing a Pr—Nd alloy, an LRE source and a TM source with ferroboron, and performing a first smelting treatment and a first strip casting treatment to obtain a first alloy flakes; wherein the LRE source is selected from one or more of a Gd—Fe alloy, a Y elementary substance, and a Ce elementary substance; the TM source is selected from one or more of a Al elementary substance, a Cu elementary substance, a Co elementary substance, a Ga elementary substance, a Nb—Fe alloy, a Zr elementary substance, and a Ti elementary substance;
performing a crushing treatment on the first alloy flakes to obtain a first powder;
performing a orientation forming and pressing treatment on the first powder to obtain a green body; and
performing a sintering treatment and tempering treatment on the green body to obtain the modified sintered neodymium-iron-boron permanent magnetic material.

8. The preparation method for the modified sintered neodymium-iron-boron permanent magnetic material according to claim 7, further comprising:
mixing a Pr—Nd alloy and a TM′ source with ferroboron, and performing a second smelting treatment and a second strip casting treatment to obtain a second alloy flakes; wherein the TM′ source is selected from one or more of a Al elementary substance, a Cu elementary substance, a Co elementary substance, a Ga elementary substance, a Nb—Fe alloy, a Zr elementary substance, and a Ti elementary substance;
adding the second alloy flakes during the crushing treatment to perform the crushing treatment with both the first alloy flakes and the second alloy flakes, so as to obtain a second powder; and
mixing the second powder with a lubricant before the orientation forming;
preferably, the crushing treatment sequentially comprising a hydrogen decrepitation treatment and a jet-milling, wherein an antioxidant is added during the jet-milling, and the second powder is obtained after the jet-milling.

9. The preparation method for the modified sintered neodymium-iron-boron permanent magnetic material according to claim 7, wherein a weight ratio of the first powder, the antioxidant to the lubricant is 100:(0.05-0.2):(0.03-0.15); and
preferably, a mean particle size of the first powder is selected from 3.0 μm to 3.8 μm.

10. The preparation method for the modified sintered neodymium-iron-boron permanent magnetic material according to claim 8, wherein a weight ratio of a total weight of the first powder and the second powder, the antioxidant to the lubricant is 100:(0.05-0.2):(0.03-0.15); and
preferably, each of mean particle sizes of the first powder and the second powder is selected from 3.0 μm to 3.8 μm.

11. The modified sintered neodymium-iron-boron permanent magnet material according to claim 2, further comprising a second alloy, the second alloy represented by formula (II): (Pr_{0.25}Nd_{0.75})xTM′yFe100_{%-x-y-z}B_{z} (II), wherein TM′ is selected from one or more of elements Al, Cu, Co, Ga, Nb, Zr, and Ti, x is 35% to 45%, y is 0.5% to 9%, and z is 0.5% to 0.9%;
preferably, x is 38% to 42%, y is 1.6% to 4.5%, and z is 0.6% to 0.8%.

12. The preparation method for the modified sintered neodymium-iron-boron permanent magnet material according to claim 7, wherein a is 7% to 16%, b is 16% to 26%, c is 0.7% to 3.3%, and d is 0.92% to 0.98%.
